(19) United States
(12) Patent Application Publication
(10) Pub. No.: US 2024/0411131 A1
(43) Pub. Date: Dec. 12, 2024

(54) IMAGE ASSEMBLY AND ELECTRONIC SYSTEM

(71) Applicant: PanelSemi Corporation, New Taipei City (TW)

(72) Inventor: Yu-Kai LIN, New Taipei City (TW)

(21) Appl. No.: 18/737,037

(22) Filed: Jun. 7, 2024

Related U.S. Application Data
(60) Provisional application No. 63/507,309, filed on Jun. 9, 2023.

(51) Int. Cl. G02B 27/01

(52) U.S. Cl. CPC G02B 27/0101; G02B 2027/0118

(57) ABSTRACT

An image assembly and an electronic system thereby are provided. The image assembly includes a light-transmissive substrate. The light-transmissive substrate is provided with a light projection surface. The light projection surface defines a plurality of light projection areas, and each of the light projection areas is defined with one or more first regions and a second region. The first region is neighbored by the second region. A light energy projected on the first regions is at least two times greater than a light energy projected on the second region.

### BACKGROUND

### Technology Field

The disclosure relates to an image assembly and specifically refer to an image assembly adapted to field of Head-Up Display.

### Description of Related Art

A head-up display (HUD) is an auxiliary image display device used in mobile machines. It first appeared in military aircraft to reduce the frequency of pilots needing to lower their heads. Generally, it uses the principle of optical reflection to project important information onto a display substrate (or windshield). However, the display substrate installed independently of the windshield takes up a lot of space in the small cockpit space. In addition, the projection method that directly projects the image onto the windshield usually projects the image as a whole onto the windshield, and the windshield sacrifices the image for a certain degree of transparency.

### SUMMARY

One or more exemplary embodiments of this disclosure are to provide an image assembly and an electronic system provided with the image assembly, beneficial of the precision of the light projection or/and the saving of the power consumption.

One or more exemplary embodiments of this disclosure are to provide an image assembly providing an image surface without conductive layer(s) or trace(s) and components thereby.

One or more exemplary embodiments of this disclosure are to provide an image assembly, which includes a light-transmissive substrate. The light-transmissive substrate is provided with a light projection surface. The light projection surface defines a plurality of light projection areas. Each of the light projection areas are defined with one or more first regions and a second region, and the first region is neighbored by the second region. A light energy projected on the first regions is at least two times greater than a light energy projected on the second region.

In one or more exemplary embodiments, the light-transmissive substrate is curved.

In one or more exemplary embodiments, the light projection areas are arranged in a continuous manner, and each of the light projection areas are neighbored with one another.

In one or more exemplary embodiments, a quantity of the one or more first regions within ones of the light projection areas is plural.

In one or more exemplary embodiments, the light-transmissive substrate is curved.

In one or more exemplary embodiments, the light-transmissive substrate is a resilient film.

In one or more exemplary embodiments, the light-transmissive substrate is a windshield.

In one or more exemplary embodiments, a measured area of the first region is millimeter-scaled or smaller.

In one or more exemplary embodiments, a light spot generated by a light beam from a light source at least covers the first region of the light projection area.

In one or more exemplary embodiments, the light beam is IR laser.

In one or more exemplary embodiments, the first region of the light projection areas is functioned of a character of reflecting or scattering, and the character of reflecting or scattering of the first region is at least two times greater than that of the second region.

In one or more exemplary embodiments, the first region is functioned of either one or both of reflecting and scattering, and distributed along the light projection surface of the light-transmissive substrate, and the one or ones of the first regions are dot(s), line(s) or layered-structure(s).

In one or more exemplary embodiments, ones of the first regions of the light projection area in rows are functioned of reflecting, other ones of the first regions of the light projection area in rows are functioned of scattering, and the rows of reflecting portions and the rows of scattering portions are not parallel with each other.

In one or more exemplary embodiments, two adjacent ones of the first regions define a first distance in a first direction, and two adjacent ones of the first regions define a second distance in a second direction, and at least one of the first distance and the second distance is no less than zero.

In one or more exemplary embodiments, two adjacent ones of the first regions define a first distance in a first direction, and two adjacent ones of the first regions define a second distance in a second direction, and either one or both of the first distance and the second distance is not equal spacing.

In one or more exemplary embodiments, the light energy is defined as an average character reference of per unit area.

In one or more exemplary embodiments, a measured area of the second region is at least two times greater than a measured area of the first region.

In one or more exemplary embodiments, the image assembly further defines one or more reference marks, relative to the first region of a corresponding one or ones of the light projection areas.

In one or more exemplary embodiments, the one or ones of the reference marks is/are set other than the light projection areas.

One or more exemplary embodiments of this disclosure are to provide an electronic system, which includes an image assembly, and a light source controller projecting one or more light beams onto the light projection areas of the light projection surface of the light-transmissive substrate in a respective manner. The light beams of the light source controller scan ones or all of the light projection areas over within a timeframe, and the light source controller generates a plurality of timeframe within one second.

In one or more exemplary embodiments, the electronic system further includes a detector electrically connected to the light source controller, wherein the detector catches a user eye, and delivers a user position of the user eye to the light source controller, and the light source controller modifies an angle of the light beams corresponding to the user position.

In one or more exemplary embodiments, the light source controller includes a target-seeking light source and a target-firing light source; the target-seeking light source generates a plurality of seeking shots, while the target-firing light source generates a plurality of firing shots; and a light energy of the firing shots projected on the light projection surface are times of that of the seeking shots.

In one or more exemplary embodiments, the target-seeking light source and the target-firing light source are the same light source; the light energy of the light source is in an energy-general state as the seeking shots are acquired, and the light energy is capable of modifying to an energy-boost state as the firing shots are acquired.

In one or more exemplary embodiments, the target-seeking light source and the target-firing light source are different light sources; and the light energy of the seeking shots is in an energy-general state and the light energy of the firing shots in an energy-boost state.

### BRIEF DESCRIPTION OF THE DRAWINGS

FIG. 1A is a schematic diagram showing an image assembly according to an embodiment of this disclosure;

FIG. 1B is a side view of the image assembly of this disclosure, wherein the image assembly is applied in an electronic system (therefore, FIG. 1B also shows the side view of the electronic system);

FIG. 2A is a schematic diagram of an image assembly of this disclosure, wherein the image assembly is applied in an electronic system (therefore, FIG. 2A also shows the schematic diagram of the electronic system);

FIG. 2B is a schematic diagram of another image assembly of this disclosure, wherein the image assembly is applied in an electronic system (therefore, FIG. 2B also shows the schematic diagram of the electronic system);

FIG. 3 is a schematic diagram of another image assembly of this disclosure, wherein the image assembly is applied in an electronic system (therefore, FIG. 3 also shows the schematic diagram of the electronic system);

FIG. 4A is a schematic diagram of another electronic system of this disclosure;

FIG. 4B is a side view of the electronic system of FIG. 4A;

FIG. 5A is a schematic diagram of another electronic system of this disclosure; and

FIG. 5B is a side view of the electronic system of FIG. 5A.

### DETAILED DESCRIPTION OF THE DISCLOSURE

The disclosure will become more fully understood from the detailed description and accompanying drawings, which are given for illustration only, and thus are not limitative of the present disclosure.

The present disclosure will be apparent from the following detailed description, which proceeds with reference to the accompanying drawings, wherein the same references relate to the same elements.

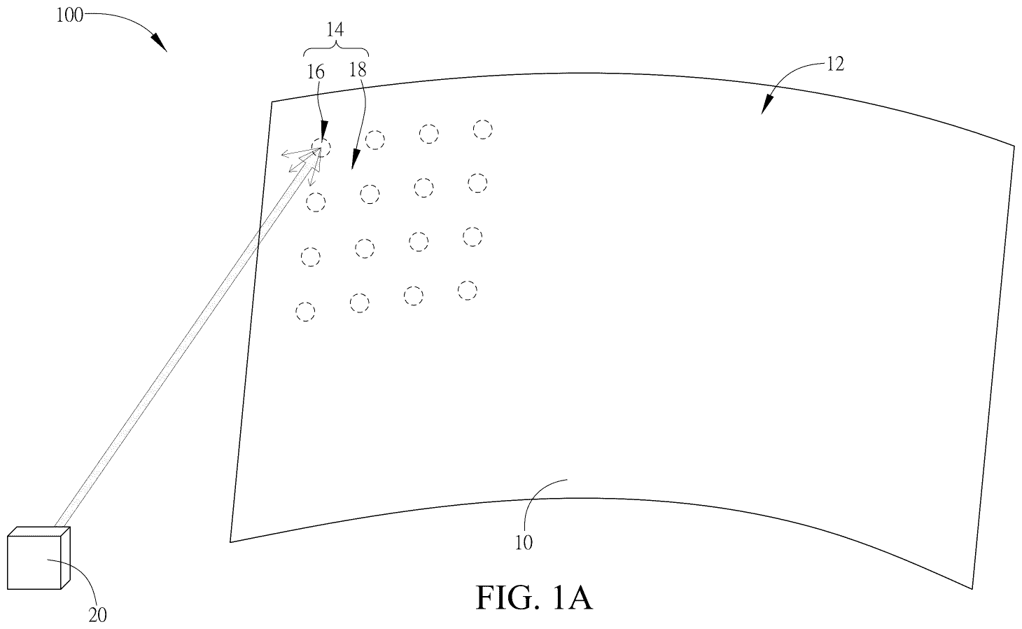

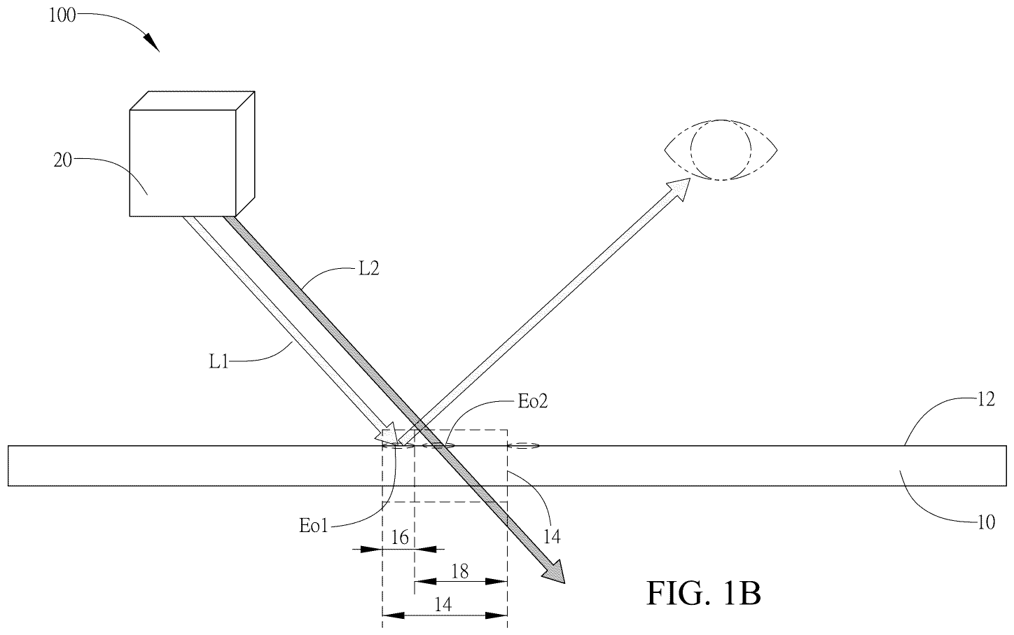

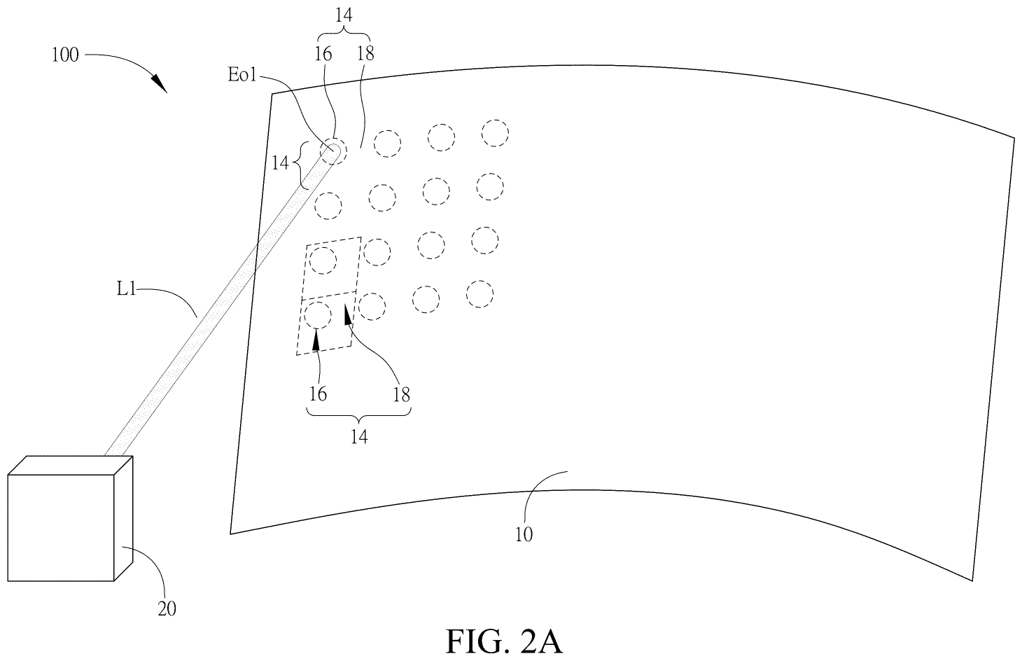

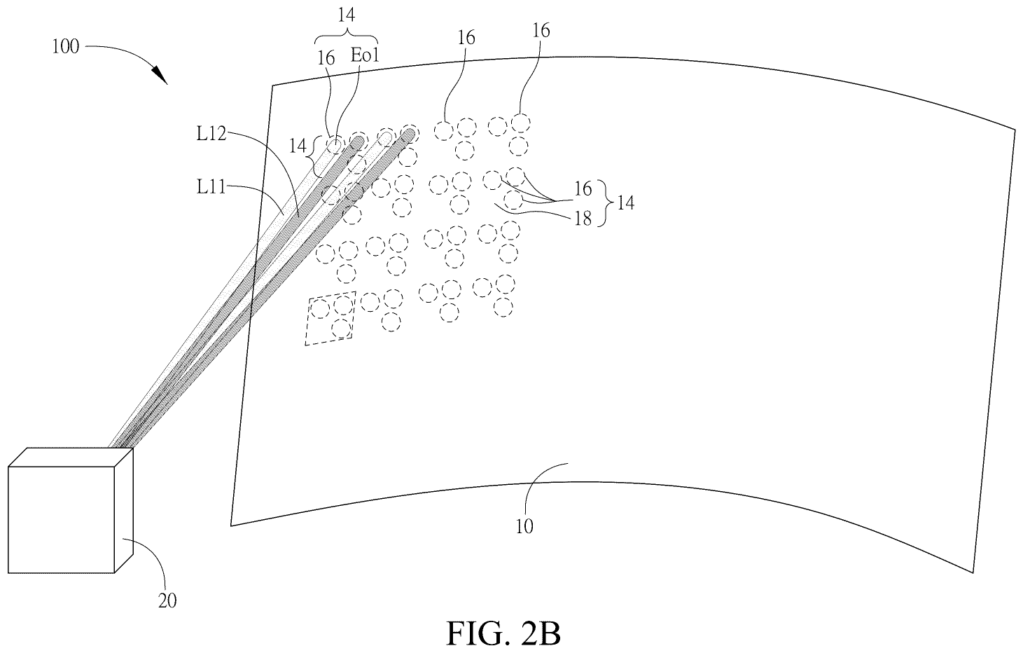

This embodiment in FIGS. 1A to 2B relates to an image assembly 100, which includes a light-transmissive substrate 10 provided with a light projection surface 12. The light projection surface 12 defines a plurality of light projection areas 14, and one or more of the light projection areas 14 are provided with one or more first regions 16 and a second region 18. The first region 16 is neighbored by the second region 18. A light energy Eo1 projected on the first regions 16 is at least two times greater than a light energy Eo2 projected on the second region 18. Here, a user and a light beam from the light source are arranged at the same side of the light-transmissive substrate 10, and the user can see information, called as an image in this disclosure, shown on the light projection surface 12 due to reflection or/and scattering of the light beams.

As you may know, the second region 18 has a light transmission rate greater than that of the first region 16 and is capable of transparency more than that of the first region 16, so that the user can still see through what happened behind the light-transmissive substrate 10 and get the information shown on the light projection surface 12 at the same time.

The light projection areas 14 are arranged in a continuous manner, and the light projection areas 14 are neighbored with one another. In some cases, the light projection areas 14 could be arranged in a matrix.

A quantity of the one or more first regions 16 within ones of the light projection areas 14 may be one or plural. In some cases, a monochrome image may be obtained in FIGS. 1A, 1B, 2A, but not limited. In some cases, to further acquire a colorful image in the similar arrangement of the light projection areas 14, the first regions 16 of the corresponding light projection area 14 are plural, referred in FIG. 2B, corresponding to various colored light beams L1 and L2 of the laser source. In this case, each of the light projection areas 14 representing one of the pixels of the image is deliberated.

The light-transmissive substrate 10 may be curved, flexible, resilient, or any feature including any or any combination there above. The light-transmissive substrate 10 maybe a windshield, or a film ready for attaching onto the windshield. In some cases, a measured area of the first region 16 is millimeter-scaled or smaller. In some cases, a measured area of the second region 18 is at least two times greater than a measured area of the first region 16. In some cases, the second region 18 encompasses the leftover of the first region 16, as the first region 16 is at a corner of the light projection area 14. In other words, the second region 18 is non first region 16.

In some cases, the light energies Eo1 and Eo2 are respectively generated by light beams L1 and L2, which project light spots with different energy levels, as illustrated in FIGS. 2A and 2B, on the light projection surface 12. In this case, the light spot (for easy reading, it is represented as numeral Eo1 in this case) projected on the first region 16 at least covers the first region 16 of the light projection area 14, the light spot (for easy reading, it is represented as numeral Eo2 in this case) projected on the second region 18 is located within the second region 18 but not limited to fully covering the second region 18. In some cases, the light spot (it is also represented as numeral Eo1 in this case) may further cover the second region 18 of the light projection area 14.

In some cases, at least the first region 16 of the light projection area 14 may function of a character of reflecting or a scattering, so that the character of reflecting or scattering of the first region 16 is at least two times greater than that of the second region 18. In another way, the first region 16 is functioned of a character of either one or both of reflecting and scattering, distributed along the light projection surface 12 of the light-transmissive substrate 10. In some cases, the second region 18 may also function of a character of reflecting or scattering, but do not conflict the relationship between the first region 16 and the second region 18.

One or ones of the first regions 16 are formed of dot(s), line(s) or layered-structure(s). In the case of the dot(s), two adjacent ones of the first regions 16 may be bumps so that the light projection surface 12 of the light-transmissive substrate 10 is uneven and two adjacent ones of the first regions 16 is spaced with a predetermined distance. In the case of the line(s), two adjacent ones of the first regions 16 may be elongated and linked together on either direction in a continuous status or consecutive status. In the case of the layered-structure(s), the function result may be the same, but the bumps or lines are instead of the structured layer(s), which may be reflection or scatter film, or a film mixed up the previous features. The layered-structure(s) may be embedded in the light-transmissive substrate 10, so that the light projection surface 12 of the light-transmissive substrate 10 is even. To be noted, the shape and the configuration of the first regions 16 are not limited.

In some cases, ones of the first regions 16 of the light projection area 14 in rows are functioned of reflecting, ones of the first regions 16 of the light projection area 14 in other rows are functioned of scattering, and the rows of reflecting portions and the rows of scattering portions are not limited to parallel with each other. In other words, some rows of the first regions 16 are functioned of reflecting, some other rows of the first regions 16 are functioned of scattering, and it means the reflecting rows of first regions 16 and the scattering rows of first regions 16 could be arranged in a regular or irregular way. In some cases, the reflecting rows of first regions 16 and the scattering rows of first regions 16 could staggered. In some cases, the reflecting rows of first regions 16 and the scattering rows of first regions 16 could be parallel. In some cases, the reflecting rows of first regions 16 and the scattering rows of first regions 16 could be not parallel at an angle. The first regions 16 of the light projection area 14 are not limited to be divided into rows, but also partial lines in rows, parts in rows, or the like. These arrangements could be implemented in a separate or combined manner.

In either case mentioned above, two adjacent ones of the first regions in two adjacent light projection area 14 may define a first distance in a first direction, and two adjacent ones of the first regions may define a second distance in a second direction. In some cases, at least one of the first distance and the second distance is no less than zero. In some cases, either one or both of the first distance and the second distance is not equal spacing (or is a variable value), but not limited.

For further comprehension, the light energy is an average character reference per unit area. To be further definition, the light energy is an illuminance, which is the total luminous flux incident on a surface per unit area.

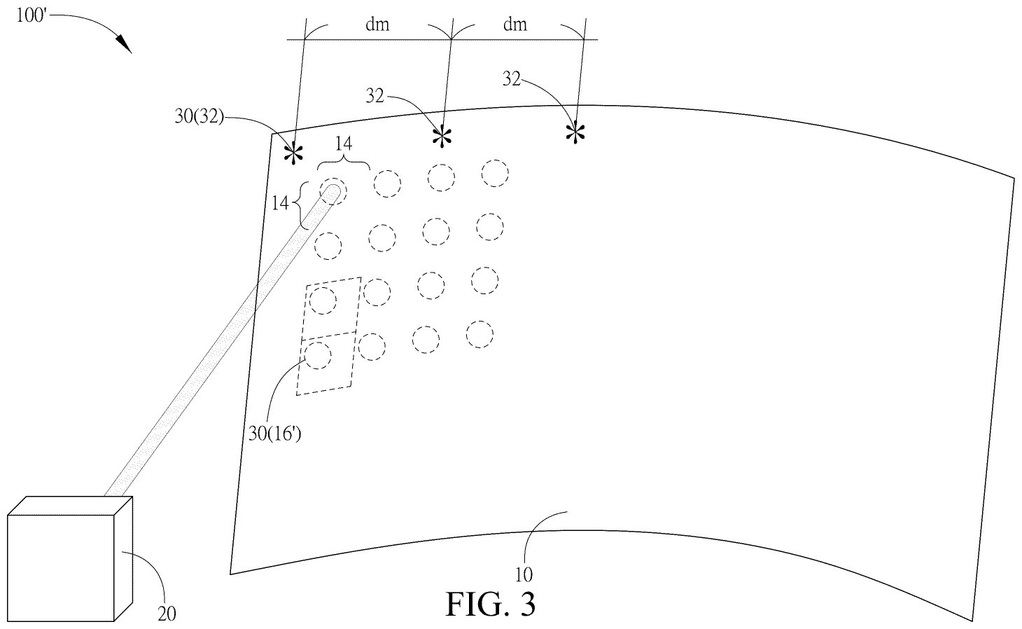

The image assembly 100′ could be further defined with one or more reference marks 30, which is illustrated in a star sign 32 in FIG. 3, relative to the first region 16 of a corresponding one or ones of the light projection areas 14. In some cases, the reference marks 30 are markings 32 arranged at the corner of the light projection surface 12 of the light-transmissive substrate 10. In some cases, the reference marks 30 (markings 32) are arranged at regular or irregular intervals dm on the light projection surface 12 of the light-transmissive substrate 10. In some cases, the one or ones of the reference marks 30 could be picked from the light projection areas 14, such as a selected first region 16′. In some cases, the one or ones of the reference marks 30 may be set other than the light projection areas 14. The reference marks 30 help the light source hitting on a targeted one or targeted ones of the first regions 16 with greater precision.

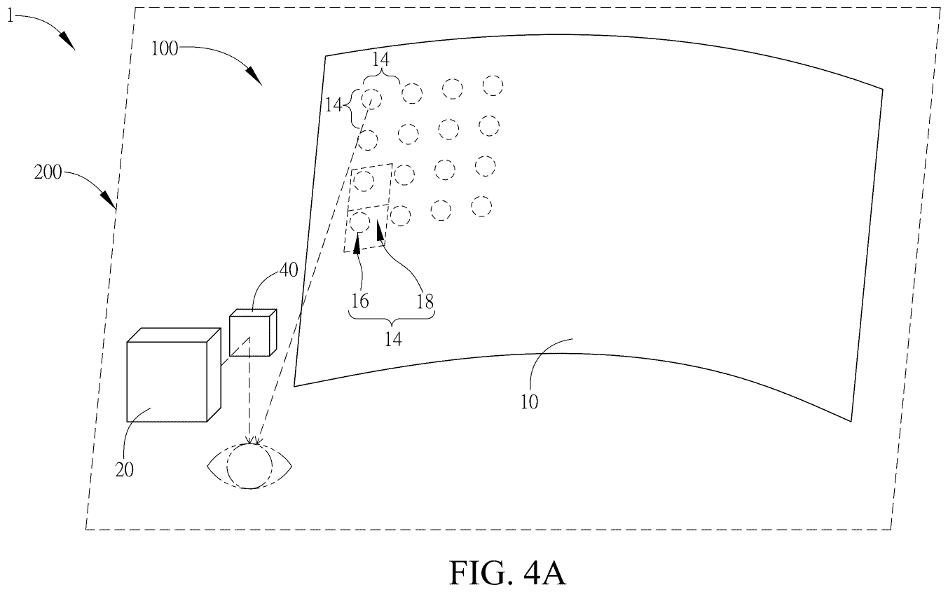

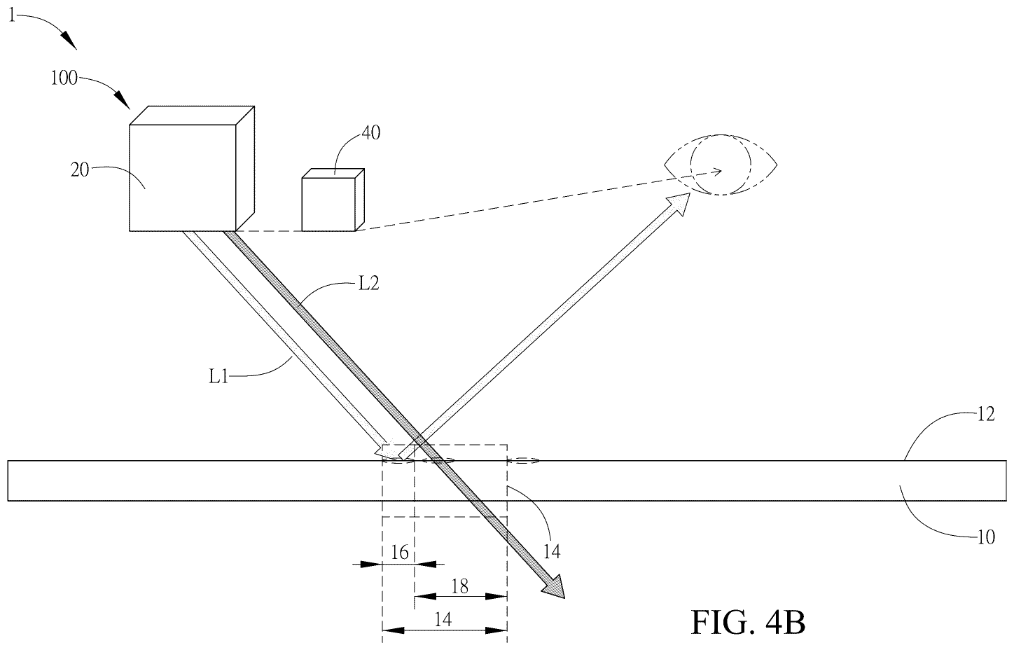

In another embodiment of this invention illustrated in FIGS. 4A and 4B, an electronic system 1 is provided and includes the image assembly 100 adapted for an appropriation projection face 200 of a mobile machine, such as a windshield of a vehicle, an aircraft, or the like, and a light source controller 20 projecting one or more light beams onto the light projection areas 14 of the light projection surface 12 of the light-transmissive substrate 10 in a respective manner, wherein the light beams of the light source controller 20 scan ones or all of the light projection areas over within a timeframe, and the light source controller 20 may generate a plurality of timeframe within one second, in which a frame rate (commonly expressed in frames per second or FPS) is provided and is typically the frequency (rate) to describe consecutive images (frames) are captured or displayed.

An electronic system 1 further includes a detector 40 electrically connected to the light source controller 20. The detector 40 can catch a position of a user eye and deliver a user position in accordance with the user eye forward to the light source controller 20, and the light source controller 20 modifies an angle of the light beams corresponding to the user position. The detector 40 may further catch the movement trajectory of user eye and forward to the light source controller 20. Thus, the light source controller 20 can always project the light beams with the correct angle for user eye, and further project the light beams with the correct angle for various users. The detector 40 is beneficial to provide another way to precisely convey the image, more qualified than it without a detector, to the user. Furthermore, different angle of the light beams is for conveying the image to different users, which improves privacy for users and saves the power consumption of the light source controller 20.

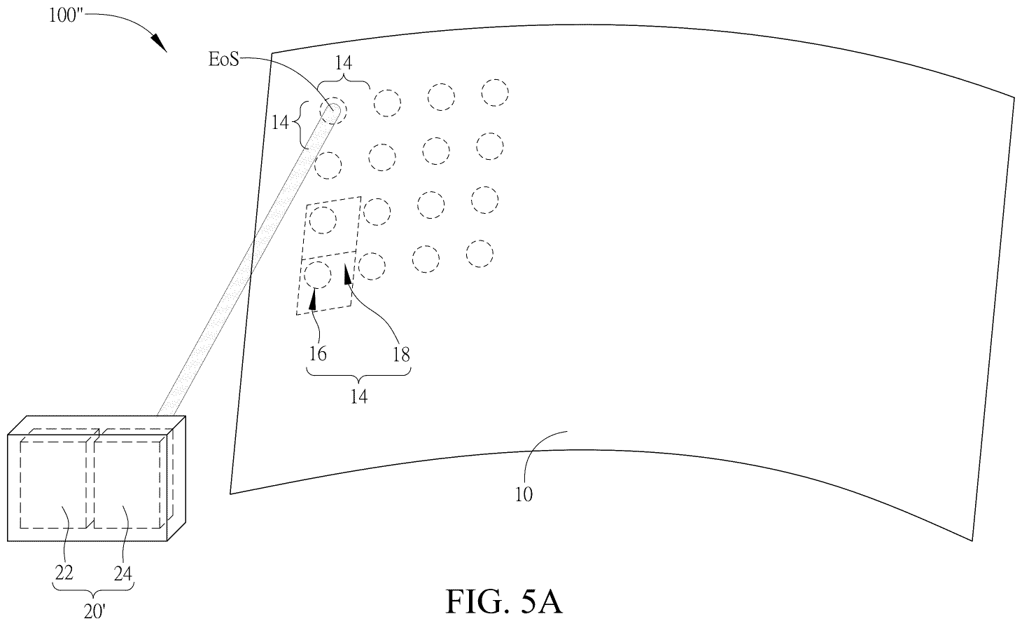

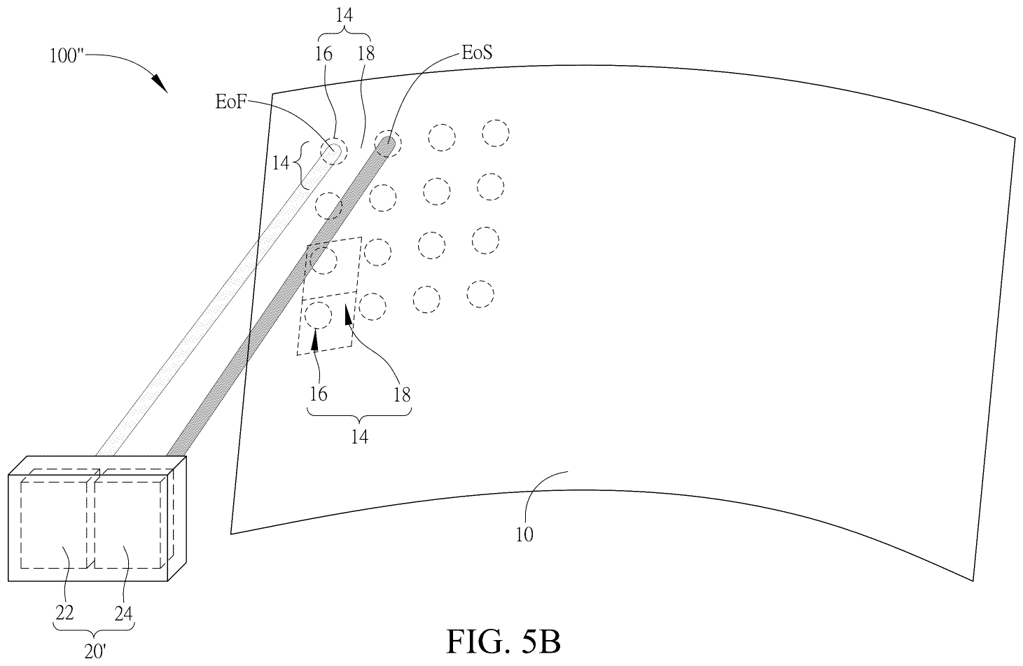

In another case, the light source controller 20′ may be functioned of a target-firing light source 22 or/and further a target-seeking light source 24. The target-seeking light source 24 generates a plurality of seeking shots, and the target-firing light source 22 generates a plurality of firing shots. It is worth noting that the aforementioned features in the image component 100 are at least achieved by the firing light source 22; and the seeking light source 24 is provided to help improving the projection accuracy of the image. In addition, a light energy EoF projected on the firing shots are times of that of the seeking shots EoS, and it helps saving the power consumption of the light source controller 20. In some cases, the target-seeking light source 24 and the target-firing light source 22 are designed as the same light source, not illustrated. In this case, the light energy projected on the light source 20′ is in an energy-general state as the seeking shots are acquired, and the light energy is capable of being modified to an energy-boost state as the firing shots are acquired. In some cases, the target-seeking light source 24 and the target-firing light source 22 are different light sources, illustrated in FIGS. 5A and 5B, which can be integrated in one light source 20′. The light energy projected on the seeking shots from the target-seeking light source 24 is kept in an energy-general state and the light energy projected on the firing shots from the target-firing light source 22 is kept in an energy-boost state. For clear description, the target-seeking light source 24 and the target-firing light source 22 may be housed together or separately.

In summary, the image assembly according to the present invention includes a light-transmissive substrate having a light projection surface. The light projection surface defines a plurality of light projection areas, each of which defines one or more first regions and a second region adjacent to one or more of the first regions. The light energy projected to the first region is at least twice the light energy projected to the second region, thereby achieving the effect of reducing power consumption. It's also achieved accuracy conducive to light projection through the target-seeking beam. Therefore, the image assembly of the present invention and the electronic system using the image assembly can still provide an image display surface without conductive layers or wires.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An image assembly, comprising:
a light-transmissive substrate provided with a light projection surface, wherein
the light projection surface defines a plurality of light projection areas, each of the light projection areas are defined with one or more first regions and a second region, and the first region is neighbored by the second region; and
a light energy projected on the first regions is at least two times greater than a light energy projected on the second region.

2. The image assembly as claimed in claim 1, wherein the light projection areas are arranged in a continuous manner, and each of the light projection areas are neighbored with one another.

3. The image assembly as claimed in claim 1, wherein a quantity of the one or more first regions within ones of the light projection areas is plural.

4. The image assembly as claimed in claim 1, wherein the light-transmissive substrate is curved.

5. The image assembly as claimed in claim 1, wherein the light-transmissive substrate is a resilient film.

6. The image assembly as claimed in claim 1, wherein the light-transmissive substrate is a windshield.

7. The image assembly as claimed in claim 1, wherein a light spot generated by a light beam from a light source at least covers the first region of the light projection area.

8. The image assembly as claimed in claim 7, wherein the light beam is IR laser.

9. The image assembly as claimed in claim 1, wherein the first region of the light projection area is functioned of a character of reflecting or scattering, and the character of reflecting or scattering of the first region is at least two times greater than that of the second region.

10. The image assembly as claimed in claim 1, wherein the first region is functioned of either one or both of reflecting and scattering, and distributed along the light projection surface of the light-transmissive substrate, and the one or ones of the first regions are dot(s), line(s) or layered-structure(s).

11. The image assembly as claimed in claim 10, wherein ones of the first regions of the light projection area in rows are functioned of reflecting, other ones of the first regions of the light projection area in rows are functioned of scattering, and the rows of reflecting portions and the rows of scattering portions are not parallel with each other.

12. The image assembly as claimed in claim 10, wherein two adjacent ones of the first regions define a first distance in a first direction, and two adjacent ones of the first regions define a second distance in a second direction, and at least one of the first distance and the second distance is no less than zero.

13. The image assembly as claimed in claim 10, wherein two adjacent ones of the first regions define a first distance in a first direction, and two adjacent ones of the first regions define a second distance in a second direction, and either one or both of the first distance and the second distance is not equal spacing.

14. The image assembly as claimed in claim 1, wherein the light energy is defined as an average character reference of per unit area.

15. The image assembly as claimed in claim 1, wherein a measured area of the second region is at least two times greater than a measured area of the first region.

16. The image assembly as claimed in claim 1, further defining one or more reference marks, relative to the first region of a corresponding one or ones of the light projection areas.

17. The image assembly as claimed in claim 1, further defining one or more reference marks, wherein the one or ones of the reference marks is/are picked from the light projection areas.

18. An electronic system, comprising:
an image assembly as claimed in claim 1 adapted for a mobile machine; and
a light source controller projecting one or more light beams onto the light projection areas of the light projection surface of the light-transmissive substrate in a respective manner, wherein the light beams of the light source controller scan ones or all of the light projection areas over within a timeframe, and the light source controller generates a plurality of timeframe within one second.

19. The electronic system as claimed in claim 18, further including a detector electrically connected to the light source controller, wherein the detector catches a user eye, and delivers a user position of the user eye to the light source controller, and the light source controller modifies an angle of the light beams corresponding to the user position.

20. The electronic system as claimed in claim 18, wherein the light source controller includes a target-seeking light source and a target-firing light source; the target-seeking light source generates a plurality of seeking shots, while the target-firing light source generates a plurality of firing shots; and a light energy of the firing shots projected on the light projection surface are times of that of the seeking shots.
